(19) United States
(12) Patent Application Publication
(10) Pub. No.: US 2006/0149676 A1
(43) Pub. Date: Jul. 6, 2006

(54) Method and apparatus for providing a secure move of a decrpytion content key

(76) Inventors: Eric J. Sprunk, Carlsbad, CA (US); Alexander Medvinsky, San Diego, CA (US)

Correspondence Address: PATTERSON & SHERIDAN L.L.P., 595 SHREWSBURY AVE, STE 100, FIRST FLOOR, SHREWSBURY, NJ, 07702, US

(21) Appl. No.: 11/027,830

(22) Filed: Dec. 30, 2004

(51) Int. Cl. H04L 9/00

(52) U.S. Cl. 705/50

(57) ABSTRACT

The present invention discloses an apparatus and method for providing a secure move of a content decryption key within or between domains. Namely, the present invention addresses the single copy usage rule by restricting the movement of the decryption key instead of restricting the movement of the encrypted content itself.

### BACKGROUND OF THE INVENTION

1. Field of the Invention

Embodiments of the present invention generally relate to digital rights management (DRM). More specifically, the present invention relates to a method and apparatus for providing a secure move of a decryption key within a domain or between domains. Secure move of a decryption key provides for a secure move of the encrypted data itself-since copies of encrypted data cannot be utilized without the corresponding decryption key.

2. Description of the Related Art

Digital contents have gained wide acceptance in the public. Such contents include, but are not limited to: movies, videos, music and the like. As such, many consumers and businesses have digital media devices and/or systems that enable the reception of such digital multimedia contents via various communication channels, e.g., via a wireless link such as a satellite link or a wired link such as cable connections and/or telephony based connections such as DSL and the like.

Irrespective of the communication channels that are employed to receive the digital contents, owners of digital contents and the service providers (e.g., a cable service provider, a telecommunication service provider, a satellite-based service provider, merchants and the like) who provide such digital contents to subscribers or users are concerned with the protection of such digital contents. To illustrate, a service provider may receive a request from a user to download a movie as a purchase. Certainly, the movie can be encrypted and forwarded electronically to the user. However, it should be noted that an encrypted copy of the content may commonly reside on a storage device, e.g., a hard disk of the user and it can be easily copied as many times as a user wishes. Generally, it is very difficult to control distribution of already encrypted content. Typically, a content owner is willing to allow a user to move the content between a plurality of devices (e.g., owned by the same or other user), but content owners commonly prohibit more than one copy of this content to exist at any one time. Given the ease of copying encrypted content by the users, this poses a challenging problem for content owners.

Thus, there is a need in the art for a method and apparatus for providing a secure move of content within or between domains.

### SUMMARY OF THE INVENTION

In the present invention, the term content refers to any object in digital form, not limited to movies, videos, music and the like. Therefore, the term content decryption key (CK) refers to a cryptographic decryption key that will decrypt a protected digital object, where this digital object is not limited to movies, videos, music and the like.

In one embodiment, the present invention discloses an apparatus and method for providing a secure move of a content decryption key within or between domains. In one embodiment, a first domain encrypts the content decryption key (CK) and sends the encrypted content decryption key (CK) to a second domain. Once the second domain has properly decrypted the content decryption key (CK), the second domain will send a confirmation message to the first domain confirming receipt of said encrypted content decryption key (CK). In turn, the first domain will delete the content decryption key (CK) in the first domain and will send an acknowledgement message to the second domain, where the acknowledgement message indicates that the content decryption key (CK) has been deleted in the first domain. Then, the second domain will now be allowed to use the content decryption key to access the encrypted digital content. Therefore, the present invention addresses the single copy usage rule by restricting the movement of the decryption key instead of restricting the movement of the content itself.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a high level view of a content distribution system of the present invention;

FIG. 2 illustrates a method for sending a secure content key from a first domain to a second domain in accordance with the present invention;

FIG. 3 illustrates a method for receiving a secure content key from a first domain by a second domain in accordance with the present invention; and

FIG. 4 illustrates the present invention implemented using a general purpose computer.

To facilitate understanding, identical reference numerals have been used, wherever possible, to designate identical elements that are common to the figures.

### DETAILED DESCRIPTION OF THE PREFERRED EMBODIMENT

In one embodiment of the present invention, Digital Rights Management (DRM) may specify one or more usage rules pertaining to digital contents (e.g., movies, videos, music, software applications and the like) that have been downloaded and stored locally by users, e.g., stored on a hard drive. One such usage rule is the number of copies that a user is allowed to have. Commonly, a content owner or provider may allow a user who has purchased the content to move the purchased content from one user device to another user device or to allow the user to loan the content to another user. Namely, the content owner would want the user to handle the content as if it is physically stored on a CD or a DVD, where physically moving the CD or DVD from one multimedia player to another multimedia player is allowed. Unfortunately, if the content is electronically stored on a hard drive or other storage media of the user, it is very difficult to enforce this usage rule.

To address this criticality, the present invention acknowledges that an encrypted copy of the content may reside on a hard disk and can be easily copied as many times as a user wishes. Generally, it is very difficult to control distribution of already encrypted content. However, distribution of the corresponding content decryption key can be controlled, thereby achieving an equivalent result desired by the content owner. Namely, a device needs to gain access to both the encrypted content and the decryption key, in order for the user to be able to make use of that content. Therefore, the present invention addresses the single copy usage rule by restricting the movement of the decryption key instead of restricting the movement of the content itself. Encrypted content may be copied or it may reside on a shared disk drive. Nevertheless, the present invention still has the ability to enforce the usage rule that only one device at-a-time can access the content.

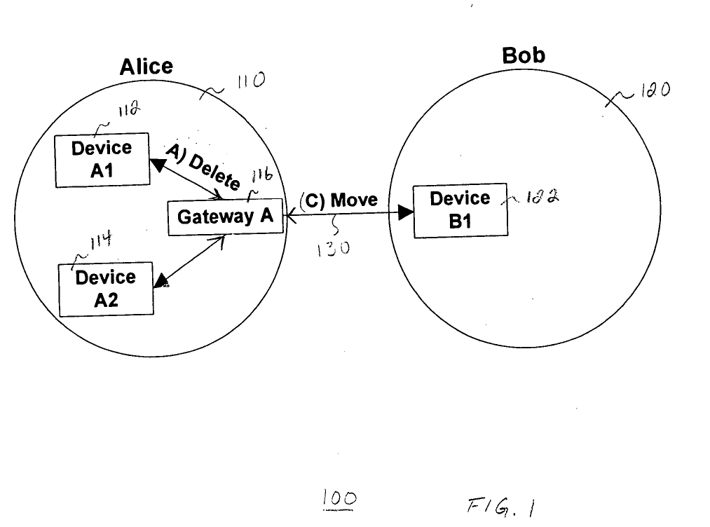

FIG. 1 illustrates a high level view of a content distribution system 100 of the present invention. The content distribution system 100 comprises a plurality of domains 110, 120, e.g., referred to as “Alice” and “Bob” as an example. A domain is broadly defined to include one or more devices or software modules that may be permanently or temporarily connected together or may be capable of exchanging data via removable media e.g., where the devices may belong to a single household. If each domain only has one device, then the present invention is interpreted to embody a secure move between two individual devices.

In one embodiment, a first domain, e.g., Alice, has two user devices or software modules A1 112 and A2 114 and optionally a gateway A 116. It is contemplated that both user devices or software modules A1 112 and A2 114 have the ability to access the encrypted content, e.g., either stored locally to both devices or at a centrally located storage. All copies of content in Alice's domain may be required to be made from Gateway A, which is then able to keep track of which device has what content in that domain.

FIG. 1 also illustrates a second domain, e.g., Bob, which has a single device B1 122. In describing the present invention, the various methods will be described as moving content 130 from a first domain 110 to a second domain 120. However, it should be noted that the present invention can be implemented within a single domain, e.g., moving content between device 112 and device 114 within a single domain 110. Finally, although the present invention is described as a secure move for protected content, it is directed towards a secure move of the decryption key that will allow access to the encrypted content. The present invention is not limited as to the movement of the encrypted content itself. Namely, the encrypted content can be downloaded from any sources including from a domain that is sending the decryption key. Alternatively, the encrypted content can reside in a centrally located storage.

It should be noted that the DRM rules and cryptographic operations are preferably executed inside a tamper-proof module, and all cryptographic keys inside a device can only be accessed in the clear when inside a tamper-proof module. For example, the tamper-proof module can be implemented as a secure hardware component within the user device. Thus, as described below, the exchanges between two domains (Alice and Bob) cannot be tampered with by the users of the devices.

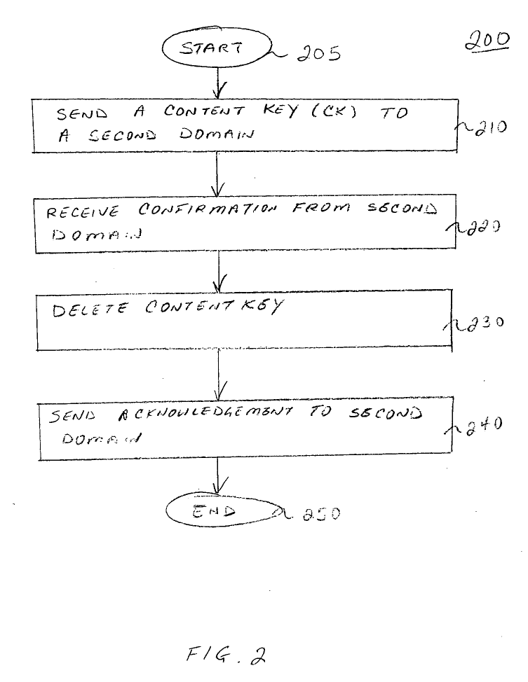

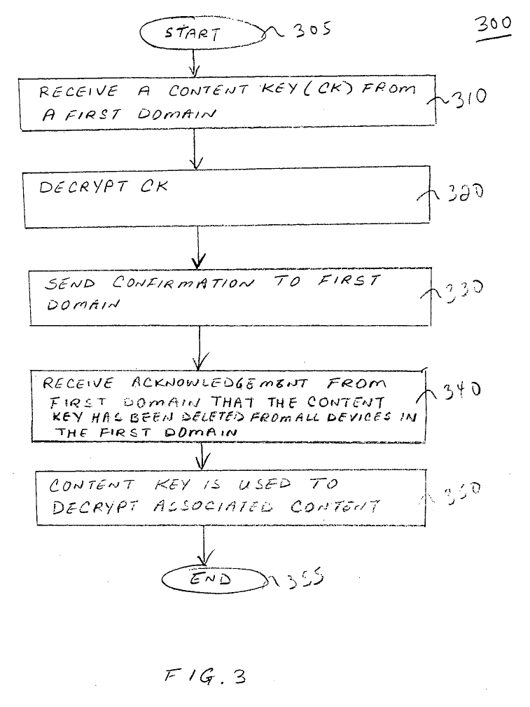

FIG. 2 illustrates a method 200 for sending a secure content key from a first domain (or device) to a second domain (or device) in accordance with the present invention. It should be noted that FIG. 2 describes a method from the perspective of a domain sending a secure content key, whereas FIG. 3 below describes a method from the perspective of a domain receiving a secure content key. In one exemplary embodiment, the two domains that are performing the secure move are “Alice” and “Bob”. The present example is premised that Alice currently has access to a content decryption key (CK) for decrypting the encrypted content and is about to transfer it to Bob. It is also premised on the fact that domains Alice and Bob already share a session key K_{AB}, i.e., a key shared by the two domains in accordance with some key agreement, e.g., Diffie-Hellman key agreement and the like.

Method 200 starts in step 205 and proceeds to step 210. In step 210, Alice sends a content decryption key (CK) via a message to Bob, where the CK is encrypted using a session key K_{AB}. In one embodiment, K_{AB} can be used to directly encrypt the CK, or there could be another encryption key that is derived from K_{AB}, where the derived encryption key is used to encrypt the CK. In one embodiment, after this step is completed, Alice still has a copy of the CK, but Alice's DRM module will no longer permit Alice to use this key to decrypt the corresponding content.

In one embodiment, the message from Alice to Bob is also authenticated, e.g., with an Hash Message Authentication Code (HMAC) using K_{AB} as the key, with an HMAC using a key derived from K_{AB}, or by encrypting CK concatenated with a hash (for example SHA-1 hash). HMAC key may also be computed with a separate session key K′_{AB}, also shared between Alice and Bob. The authentication or integrity check is important that when Bob receives this key, Bob can verify that it was not corrupted in transit (intentionally or unintentionally), so that when Alice loses the ability to access the content, Bob will gain the ability to access the same content.

In step 220, Alice receives confirmation that Bob has received the CK. Bob will only send the confirmation message to Alice if Bob was able to decrypt the CK. In one embodiment, the confirmation message from Bob also contains a nonce, where the nonce is a randomly generated integer value. Again, if authentication or integrity check is applied to the confirmation message, Alice must confirm the integrity of the confirmation message from Bob. Once confirmed, method 200 proceeds to step 230.

In step 230, Alice deletes the CK from its storage. Namely, Alice has received confirmation that Bob actually received the CK.

In step 240, Alice sends back to Bob an Acknowledgement (ACK) message that the CK has been deleted in the Alice domain. Again, integrity check can be applied to this ACK message, e.g., using a Message Authentication Code (MAC) generated either with the key K_{AB} or using another key that is derived from K_{AB}. MAC key may also be computed with a separate session key K′_{AB}, also shared between Alice and Bob. Optionally, if Alice received a nonce value N from Bob in step 220, then that same nonce value can be included in the calculation of this Message Authentication Code. Thus, the CK has been securely moved from the Alice domain to the Bob domain and method 200 ends in step 250.

FIG. 3 illustrates a method 300 for receiving a secure content decryption key from a first domain by a second domain in accordance with the present invention. Namely, FIG. 3 describes a method from the perspective of a domain receiving a secure content key.

Method 300 starts in step 305, and proceeds to step 310. In step 310, Bob (a second domain) receives an encrypted content key from Alice (a first domain).

In step 320, Bob decrypts the message. Namely, Bob decrypts the CK (e.g., using the K_{AB}) and verifies its integrity (if integrity check is employed). If integrity check fails, then Bob would inform Alice of the failed integrity check. In response, Alice may either retry the move (e.g., repeating step 210 of FIG. 2) or Alice may re-enable its access to the CK for decryption of the content. It is important that any error message sent from Bob in this step to Alice be authenticated. Otherwise, Bob may pretend that the CK was corrupted in order to circumvent the DRM rules and allow simultaneous access to the CK for both Alice and Bob.

In step 330, after the CK has been decrypted and stored, Bob sends back to Alice a confirmation message that the CK has been received. In one embodiment, this confirmation message may contain a nonce N, where the nonce is a random integer value that with high likelihood has never been seen before by Alice. In one embodiment, this same message may also contain an integrity check, for example HMAC(K_{AB}, N) or (HMAC over N using K_{AB} as the key). Alternatively, the HMAC could be calculated using another key that is derived from K_{AB}, or instead of an HMAC, some other type of Message Authentication Code function could be used. In one embodiment, if the key K_{AB} is unique to each secure move operation, then it is not necessary to send a nonce in this confirmation message, but a Message Authentication Code can still be used.

In step 340, Bob receives an ACK message from Alice. Namely, Alice sends back to Bob an Acknowledgement (ACK) message that the CK was deleted on the Alice domain. This ACK message may have integrity check using some sort of a Message Authentication Code generated either with the key K_{AB} or using another key that is derived from K_{AB}. If a nonce was sent in step 330, then that same nonce value can be included in the calculation of this Message Authentication Code. Again, integrity check can be applied to the ACK message.

In step 350, after receiving and validating the ACK message, Bob's DRM module will allow or enable the Bob domain to utilize the CK in the decryption of the associated content. Method 300 ends in step 355.

The methods of FIGS. 2 and 3 above can be expressed as an example of the messages that are exchanged between Alice and Bob during this secure move implementation. For example:
Alice→Bob: E{K_{AB}, CK} HMAC-SHA-1{K_{AB}, E{K_{AB}, CK}}
Bob→Alice: N HMAC-SHA-1{K_{AB}, “Bob” ∥N∥ CK}
Alice→Bob: HMAC-SHA-1{K_{AB}, “Alice” ∥N}
   In this example, the notation E{K_{AB}, CK} indicates CK is encrypted with the key K_{AB}. Also, the symbol ∥ indicates concatenation. For example, HMAC-SHA-1{K_{AB}, “Bob” ∥N∥CK} means that this is an HMAC-SHA-1 algorithm performed over the concatenation of the text string “Bob”, nonce value N and the clear content key CK using the key K_{AB}.

In the above methods of FIGS. 2 and 3, Alice deletes its copy of the content key CK in step 230 and Bob doesn't get enabled to decrypt the content with the CK until step 350 when Bob receives and successfully validates an ACK message from Alice. However, if that ACK message is somehow lost or corrupted, then it is possible that the content associated with the CK would become unusable because both Alice and Bob will not have a valid CK to decrypt the content.

This however would be unacceptable from the user's point of view. Therefore, Alice's acknowledgement message sent to Bob in step 240 has to be retried until it gets through and gets validated correctly. In other words, if Bob doesn't get that ACK message within a specified timeout period, Bob should re-request Alice to send this ACK message again. Alternatively, if the ACK message is rejected by Bob for some reason, then Bob should again re-request the ACK message from Alice.

In one embodiment, Alice and Bob will be capable of remembering the value of the nonce N for a long period of time (e.g., weeks). If a network outage occurs during which the ACK message from Alice to Bob doesn't get through, Alice and Bob can re-establish the connection at a later time and Alice will be able to re-send that ACK message. In one embodiment, the ACK message can also be authenticated with a new session key K′_{AB}, in the event that the old session key K_{AB} has expired before Alice's ACK message is successfully validated by Bob.

In a second embodiment, the methods of FIGS. 2 and 3 are slightly modified. This second embodiment of the secure move is different from the first embodiment in that a shared session key K_{AB} between Alice and Bob is not employed. Instead, Alice and Bob have previously exchanged their digital certificates and now possess each other's public key. Alice's public key is PA_{A} and Bob's public key is P_{B}. Their corresponding private keys are denoted as P⁻¹_{A} and P⁻¹_{B}.

The second embodiment is closely related to the embodiment as described above using FIGS. 2 and 3. As such, FIGS. 2 and 3 can still be broadly used to describe this second embodiment. This modified version of the secure move will now be described.

First, Alice sends the CK to Bob (e.g., as in step 210), where the CK is encrypted with Bob's public key P_{B}. After this step is completed, Alice still has a copy of the CK, but Alice's DRM module will no longer permit Alice to use this key to decrypt the corresponding content. In one embodiment, this message from Alice to Bob is also authenticated, e.g., with a digital signature generated with P⁻¹_{A}.

Second, Bob receives and decrypts the CK (e.g., as in steps 310 and 320) and verifies its integrity (if integrity check is available). If integrity check fails, then Bob would inform Alice and Alice can either retry the move (e.g., go back to step 210) or can re-enable her access to the CK for decryption of the content. Again, any error message sent from Bob in this step can be authenticated, thereby preventing Bob from pretending that the CK was corrupted in order to circumvent the DRM rules and allow simultaneous access to the CK for both Alice and Bob.

Third, Bob sends back to Alice a confirmation message (e.g., as in step 330) that indicates that the CK has been received. Similarly, this confirmation message may also contain a nonce N. This same message may also contain an integrity check, for example digital signature with P⁻¹_{B.}

Fourth, Alice upon receipt and validation (e.g., as in step 220) of the confirmation message from Bob deletes her copy of the CK (e.g., as in step 230). Since Alice has been informed that the key has been successfully transferred to Bob, the CK can be deleted from Alice's domain.

Fifth, Alice sends back to Bob an Acknowledgement (ACK) message that the CK was deleted on the Alice domain. This ACK message may have integrity check, e.g., digital signature with P⁻¹_{A}. If in step 220, Alice received a nonce value N from Bob, that same nonce value can be included in the calculation of this signature.

Sixth, after receiving and validating this ACK message (e.g., as in step 340), Bob's DRM module will allow the Bob domain (e.g., as in step 350) to utilize the CK in the decryption of the associated content.

The second embodiment can also be expressed as an example of the messages that are exchanged between Alice and Bob during this second secure move implementation. For example:
Alice→Bob: E{P_{B}, CK} Signature{P⁻¹_{A}, E{P_{B}, CK}}
Bob→Alice: N Signature{P⁻¹_{B}, “Bob” ∥N∥ CK}
Alice→Bob: Signature{P⁻¹_{A}, “Alice” ∥N}

In a third embodiment, the secure move methods as described above include several messages that may employ message integrity check. In one embodiment, the above method shows message integrity check being implemented with an HMAC using the session key K_{AB}. Alternatively, message integrity of each message can be provided using a digital signature using the sender's (Alice's or Bob's) private key.

The use of the digital signature is preferred in the case when the session key K_{AB} is established using a key agreement algorithm such as Diffie-Hellman and when Alice's key agreement public value is sent in the first message from Alice to Bob. For example:
Alice→Bob: Y_{A}E{K_{AB}, CK} Signature{P⁻¹_{A}, Y_{A} , ∥E{K_{AB}, CK}}
Bob→Alice: N HMAC-SHA-1{K_{AB}, “Bob” ∥N∥ CK}
Alice→Bob: HMAC-SHA-1{K_{AB}, “Alice” ∥N}

In this example, the notation E{K_{AB}, CK} indicates CK is encrypted with the key K_{AB}. Also, the symbol ∥ indicates concatenation. In this example, Y_{A} is Alice's Diffie-Hellman public key. Y_{B} is Bob's Diffie-Hellman public key and it has already been communicated to Alice prior to the above message sequence. In one embodiment, the session key K_{AB} is calculated on the fly by Alice, based on Alice's Diffie-Hellman private key X_{A} and Bob's Diffie-Hellman public key Y_{B}. Similarly, Bob may compute K_{AB} using X_{B} and Y_{A} (that it receives in the first message).

The above methods have been described in the context of a one to one domain interaction. In other words, a first domain is communicating directly with a second domain, but there may be scenarios where there are multiple user devices in one or both of the domains. For example, a content owner may permit a single domain (e.g., a first domain) to have a plurality of devices to have the ability to use the CK to access the content. However, if the CK is passed to another domain (e.g., a second domain), then all the devices in the first domain must surrender or delete the CK before a secure move is performed to send the CK to the second domain.

Returning to FIG. 1, this figure shows that before the secure move, Alice may have a copy of a particular content on user devices A1, A2 and on the gateway A. Gateway A is responsible for keeping track of which other devices in Alice's domain have accesses to this same content. Those other devices may share the same content decryption key CK, or they could have re-encrypted the same content using their own local key after using the CK. the same content using their own local key after using the CK.

As such, before a secure move from gateway A to Bob's Device B1 can take place (using one of the methods disclosed above), gateway A may issue a command to each of the devices that it knows has copy of this content to delete the corresponding decryption key. A secure delete can be accomplished as described below.

First, gateway A 116 sends to device A1 112 a command to delete a content key that corresponds to a content C. This command may include a randomly-generated nonce N. Device A1 may possess the same content decryption key (which is CK), or by now A1 might have re-encrypted C with another content key CK′. In one embodiment, the message from gateway A to device A1 is authenticated, e.g., with an HMAC using a shared session key K_{A1}, or with an HMAC using a key derived from K_{A1}.

Second, device A1 verifies the integrity check of the delete request (if integrity check is available). If integrity check fails, device A1 would inform gateway A and gateway A can either retry the delete message or it can abort the secure move to Bob's domain.

Third, after the second step is successful, device A1 sends back to gateway A a confirmation message that it has deleted the previously received CK. This confirmation message may also contain a message integrity check that includes nonce N, for example HMAC(K_{A1}, N).

After receiving and validating a message from device A1, gateway A would record in its database that A has deleted its content decryption key for content C. This delete method can be repeated for all other user devices in domain Alice until all devices have reported the deletion of the CK. At that point, gateway A would be the only element or device in the Alice domain to retain the CK. At this point, gateway A can implement a secure move to domain B as discussed above.

The above secure delete method can also be expressed as an example of the messages that are exchanged between A and A1 for a secure delete:

A→A1: N CKID HMAC-SHA-1{K_{A1}, “Gateway A” ∥N∥ CKID}

A1→A: HMAC-SHA-1{K_{A1}, “A1” ∥N}

Where CKID is an identifier for the content key CK. For example, CKID can be a hash of CK.

Alternatively, another embodiment of a secure delete can be implemented by using digital signatures (where digital certificates of Gateway A and A1 are assumed to have been exchanged ahead of time). For example:
A→A1: N CKID Signature{P⁻¹_{A}, “Gateway A” ∥N∥ CKID}
A1→A: Signature{P⁻¹_{A1}, “A1” ∥N}

The above set of steps would be repeated for each devices in Alice's domain that is known (by the gateway) to have access to the same content C. After only gateway A is left with the access to C, it can then perform a device-to-device secure move to Bob's device B1.

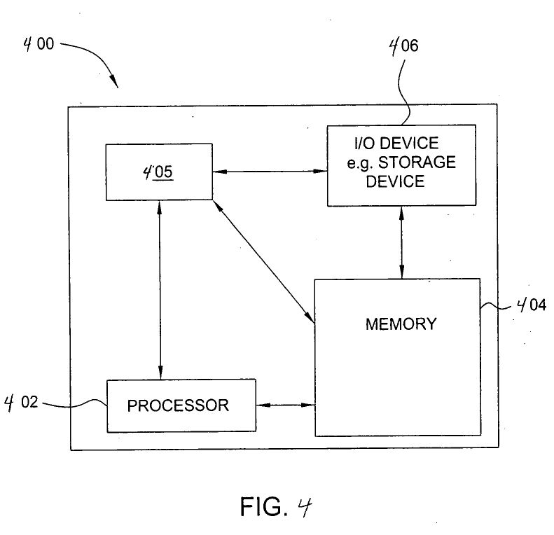

FIG. 4 is a block diagram of the present secure move apparatus being implemented with a general purpose computer or computing device. In one embodiment, the secure move apparatus is implemented using a general purpose computer or any other hardware equivalents. For example, the secure move apparatus 400 can be broadly implemented as a domain or a device within the domain 110 or 120 of FIG. 1. More specifically, the secure move apparatus 400 comprises a processor (CPU) 402, a memory 404, e.g., random access memory (RAM) and/or read only memory (ROM), a DRM module or device 405 for implementing the secure move as described above, and various input/output devices 306 (e.g., storage devices, including but not limited to, a tape drive, a floppy drive, a hard disk drive or a compact disk drive, a receiver, a decoder, a decryptor, a transmitter, a clock, a speaker, a display, an output port, a user input device (such as a keyboard, a keypad, a mouse, and the like), or a microphone for capturing speech commands).

It should be understood that the DRM module or device 405 can be implemented as a secure physical device or subsystem that is coupled to the CPU 402 through a communication channel. Alternatively, the DRM module or device 405 can be represented by one or more software applications (or even a combination of software and hardware, e.g., using application specific integrated circuits (ASIC)), where the software is loaded from a storage medium (e.g., a magnetic or optical drive or diskette) and operated by the CPU in the memory 404 of the computer. As such, the DRM module or device 405 (including associated data structures and methods employed within the encoder) of the present invention can be stored on a computer readable medium or carrier, e.g., RAM memory, magnetic or optical drive or diskette and the like.

While the foregoing is directed to embodiments of the present invention, other and further embodiments of the invention may be devised without departing from the basic scope thereof, and the scope thereof is determined by the claims that follow.

1. A method for providing a secure move of a decryption key, comprising:
encrypting the decryption key in a first domain;
sending said encrypted decryption key to a second domain;
receiving a confirmation message from said second domain confirming receipt of said encrypted decryption key;
deleting the decryption key in said first domain; and
sending an acknowledgement message to said second domain, where said acknowledgement message indicates the decryption key has been deleted in said first domain.

2. The method of claim 1, wherein said encrypted decryption key is sent to said second domain with an integrity check.

3. The method of claim 1, wherein said confirmation message is received from said second domain with an integrity check.

4. The method of claim 3, wherein said confirmation message further comprises a nonce value.

5. The method of claim 1, wherein said encrypting comprises:
encrypting the decryption key with a session key established between said first domain and said second domain.

6. The method of claim 1, wherein said encrypting comprises:
encrypting the decryption key with a public key of said second domain.

7. The method of claim 1, wherein said encrypted decryption key is sent to said second domain with an integrity check in accordance with a digital signature.

8. The method of claim 1, wherein each of said first domain and said second domain comprises at least one user device.

9. The method of claim 8, wherein said first domain further comprises a gateway, wherein each of said at least one user device within said first domain deletes said decryption key prior to said gateway sending said encrypted decryption key to said second domain.

10. The method of claim 9, wherein said deleting comprises:
deleting the decryption key from each of said at least one user device within said first domain by exchanging at least one message that employs an integrity check or a digital signature.

11. A computer-readable carrier having stored thereon a plurality of instructions, the plurality of instructions including instructions which, when executed by a processor, cause the processor to perform the steps of a method for providing a secure move of a decryption key, comprising of:
encrypting the decryption key in a first domain;
sending said encrypted decryption key to a second domain;
receiving a confirmation message from said second domain confirming receipt of said encrypted decryption key;
deleting the decryption key in said first domain; and
sending an acknowledgement message to said second domain, where said acknowledgement message indicates the decryption key has been deleted in said first domain.

12. The computer-readable carrier of claim 11, wherein said encrypted decryption key is sent to said second domain with an integrity check.

13. The computer-readable carrier of claim 11, wherein said confirmation message is received from said second domain with an integrity check.

14. The computer-readable carrier of claim 13, wherein said confirmation message further comprises a nonce value.

15. The computer-readable carrier of claim 11, wherein said encrypting comprises:
encrypting the decryption key with a session key established between said first domain and said second domain.

16. The computer-readable carrier of claim 11, wherein said encrypting comprises:
encrypting the decryption key with a public key of said second domain.

17. The computer-readable carrier of claim 11, wherein said encrypted decryption key is sent to said second domain with an integrity check in accordance with a digital signature.

18. The computer-readable carrier of claim 11, wherein each of said first domain and said second domain comprises at least one user device.

19. An apparatus for providing a secure move of a decryption key, comprising:
means for encrypting the decryption key in a first domain;
means for sending said encrypted decryption key to a second domain;
means for receiving a confirmation message from said second domain confirming receipt of said encrypted decryption key;
means for deleting the decryption key in said first domain; and
means for sending an acknowledgement message to said second domain, where said acknowledgement message indicates the decryption key has been deleted in said first domain.

20. A method for providing a secure move of a decryption key, comprising:
receiving an encrypted decryption key sent from a first domain by a second domain;
decrypting said encrypted decryption key;
sending a confirmation message to said first domain confirming receipt of said encrypted decryption key;
receiving an acknowledgement message from said first domain, where said acknowledgement message indicates the decryption key has been deleted in said first domain; and
enabling said decryption key for accessing a protected digital object.
